(19) United States
(12) Patent Application Publication
(10) Pub. No.: US 2013/0307251 A1
(43) Pub. Date: Nov. 21, 2013

(54) APPARATUS FOR COUPLING A TRAILER TO A TOWING VEHICLE

(71) Applicant: Lieuwe Faber, Glenbrook (NZ)

(72) Inventor: Lieuwe Faber, Glenbrook (NZ)

(21) Appl. No.: 13/890,719

(22) Filed: May 9, 2013

(30) Foreign Application Priority Data
May 15, 2012 (NZ) 599990

(51) Int. Cl. B60D 1/06

(52) U.S. Cl. CPC B60D 1/065
USPC 280/512

(57) ABSTRACT

The invention relates to an apparatus for improved ease and reliability of coupling a trailer to a tow-ball of a towing vehicle through a straight connection of a support member with a tow-ball. The support member is configured to abut a posterior portion of the tow-ball at a first abutting portion. A pivot arm is configured to pivot over the tow-ball to a position where a second abutting portion is adjacent an anterior portion of the tow-ball. A pivot plate connected to the support member at a first pivot and to the pivot arm at a second pivot is configured to bias the first abutting portion towards the second abutting portion to securely contact the posterior portion and the anterior portion of the tow-ball respectively.

### TECHNICAL FIELD

The present invention relates generally to an apparatus for coupling a trailer to a towing vehicle. In particular, the present invention relates to an apparatus for coupling a trailer to a tow-ball of the towing vehicle.

### BACKGROUND ART

The process of coupling a trailer to a towing vehicle with known ball and socket type couplings, can include trial and error in maneuvering the towing vehicle to align with the trailer such that the trailer tow-ball is aligned with the receiver assembly of the trailer to facilitate manual coupling of the trailer to the towing vehicle.

It can be time consuming to reverse the towing vehicle into sufficient proximity with the trailer (particularly at night when visibility is reduced). In addition the coupling process requires physical exertion by the user to manually move the trailer receiver assembly into exact alignment with the tow-ball of the towing vehicle, lift the trailer receiving assembly above the tow-ball and then lower onto the tow-ball (for example with the help of a height adjustable draw bar and jockey wheel) to enable coupling of the trailer to the towing vehicle. Such exertion can be difficult by a user with little physical ability and would depend on a number of factors such as the angle of the underlying ground surface which would influence the relative angle of the trailer towing vehicle and the type and load of the trailer.

Many apparatus have been devised to assist this coupling process such as visual alignment markers, photoelectric sensors and alerting device or ultrasonic transducers.

Although relatively inexpensive, the disadvantage of visual alignment markers is that they do not provide any positive indication of when the trailer receiver assembly is in sufficient alignment to enable coupling, with the result that the coupling process is still not reliable.

In relation to photoelectric sensors and an alerting devices, the disadvantage of these apparatus is that they can be costly to install and do not provide for an indication of alignment except in situations where the trailer hitch is in exact alignment with the trailer receiver assembly.

In relation to ultrasonic transducers, these devices can be expensive and time consuming to install and can be subject to damage by road debris or subject to theft. Furthermore, these devices require power to function and can be difficult to use reliably via a display device rather than visually in real time via the rear view mirror.

### OBJECT OF THE INVENTION

It is an object of the invention to provide an apparatus for coupling a trailer to a towing vehicle that addresses the problems of the prior art, such as those discussed above.

Alternatively, it is an object of the invention to at least provide the public with a useful choice.

### DISCLOSURE OF INVENTION

According to one aspect of the present invention there is provided an apparatus for coupling a trailer to a towing vehicle, the apparatus comprising:
a support member configured to abut a posterior portion of a tow-ball of the towing vehicle at a first abutting portion positioned at an end of the support member;
a pivot arm configured to pivot over the tow-ball to a position where a second abutting portion positioned on an end of the pivot arm is adjacent an anterior portion of the tow-ball;
a pivot plate connected to the support member at a first pivot and to the pivot arm at a second pivot

wherein

the pivot plate is configured to bias the first abutting portion towards the second abutting portion to securely contact the posterior portion and the anterior portion of the tow-ball respectively.

Preferably, the first abutting portion and the second abutting portion have a curved inner surface configured to provide maximum contact with an outer surface of the tow-ball.

More preferably, the first abutting portion and/or the second abutting portion comprise at least one friction pad positioned on the curved inner surface of the first abutting portion and/or the second abutting portion and configured to abut the outer surface of the tow-ball when the first abutting portion and/or the second abutting portion abut the outer surface of the tow-ball.

In this way, the at least one friction pad prevents damage to the tow-ball during use and reduces trailer sway while towing a trailer by a towing vehicle.

Preferably, the pivot plate comprises a lever configured to move the pivot plate towards the support member to bias the first abutting portion and the second abutting portion towards one another after the second abutting portion of the pivot arm is adjacent the anterior portion of the tow-ball.

More preferably, the lever comprises a handle to aid the user moving the lever.

Preferably, the support member also comprises a pair of guiding plates, each guiding plate attached proximal to the first abutting portion of the support member and configured to deflect the support member when in proximity with the tow-ball to a position where the first abutting portion abuts the tow-ball.

Preferably, the position of the first pivot may be moved by attaching the pivot arm to the support member at one of a series of apertures along a length of the support member via a fixing means.

Preferably, the apparatus for coupling a trailer to a towing vehicle also comprises a catch pivotally attached to the pivot plate and configured to attach to the support member to prevent movement of the pivot plate with respect to the support member.

More preferably, the catch comprises a tension spring configured to bias the catch to release from the support member.

Preferably, the apparatus for coupling a trailer to a towing vehicle also comprises a locking pin to secure the pivot plate to the support arm.

Preferably, the apparatus for coupling a trailer to a towing vehicle also comprises a linear actuator configured to move the apparatus to or from a position where the first abutting portion abuts the posterior portion of the tow-ball.

More preferably, the linear actuator is driven by an electric motor.

According to another aspect of the present invention there is provided a method of coupling a trailer to a trailer hitch, the method comprising the steps of:
a. positioning a support member to abut a posterior portion of the tow-ball of a towing vehicle at a first abutting portion positioned at an end of the support member;
b. moving a pivot arm to pivot over the tow-ball to a position where a second abutting portion positioned on an end of the pivot arm is adjacent an anterior portion of the tow-ball; and
c. moving a pivot plate connected to the support member at a first pivot and to the pivot arm at a second pivot to bias the first abutting portion and the second abutting portion towards one another to securely contact the posterior portion and anterior portion of the tow-ball respectively.

### BRIEF DESCRIPTION OF THE FIGURES

The invention will now be described by way of example only and with reference to any one of the accompanying drawings in which:

FIG. 1 shows a side view of a first preferred embodiment of the invention in the form of an apparatus for coupling a trailer to a tow-ball;

FIG. 2 shows a side view of the preferred embodiment shown in FIG. 1 with the pivot arm moved to a position where the second abutting portion is adjacent an anterior portion of the tow-ball;

FIG. 3 shows a side view of the preferred embodiment shown in FIG. 1 with the first abutting portion and the second abutting portion biased towards one another to securely abut the posterior portion and anterior portion of the tow-ball respectively;

FIG. 4 shows a plan view of another preferred embodiment of the invention with guiding plates attached;

FIG. 5 shows a side view of a second preferred embodiment of the invention in the form of an apparatus for coupling a trailer to a tow-ball with the hammer raised;

FIG. 6 shows a front view of the preferred embodiment shown in FIG. 4;

FIG. 7 shows a side view of the preferred embodiment shown in FIG. 4 with the hammer lowered;

FIG. 8 shows a front view of the preferred embodiment shown in FIG. 7;

FIG. 9 shows a sectional schematic side view of the preferred embodiment shown in FIG. 7;

FIG. 10 shows a close up sectional view of the anterior of the preferred embodiment shown in FIG. 9 coupled to a tow-ball; and

FIG. 11 shows a side view of a third preferred embodiment of the present invention in the form of an apparatus for coupling a trailer to a tow-ball.

### DETAILED DESCRIPTION OF THE INVENTION

The present invention addresses the problems identified in the prior art above by providing:
improved ease of use in coupling a trailer to a towing vehicle through a relatively simple two part coupling process and through a straight connection of a support member with the tow-ball which obviates the need for manual angling of the trailer with respect to the tow-ball to initiate coupling; and
improved reliability of coupling a trailer to a towing vehicle through the use of a mechanical apparatus.

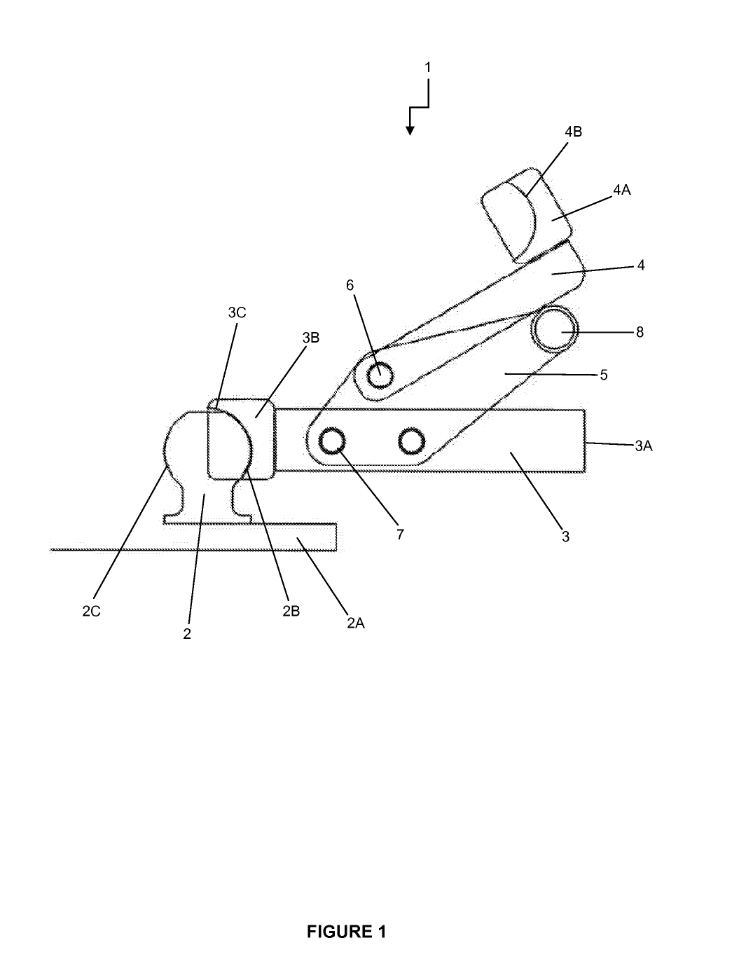

The invention is now described in relation to a first preferred embodiment of the present invention as shown in FIGS. 1a to 4. It should be appreciated that the invention may be varied from the Figures without departing from the scope of the invention.

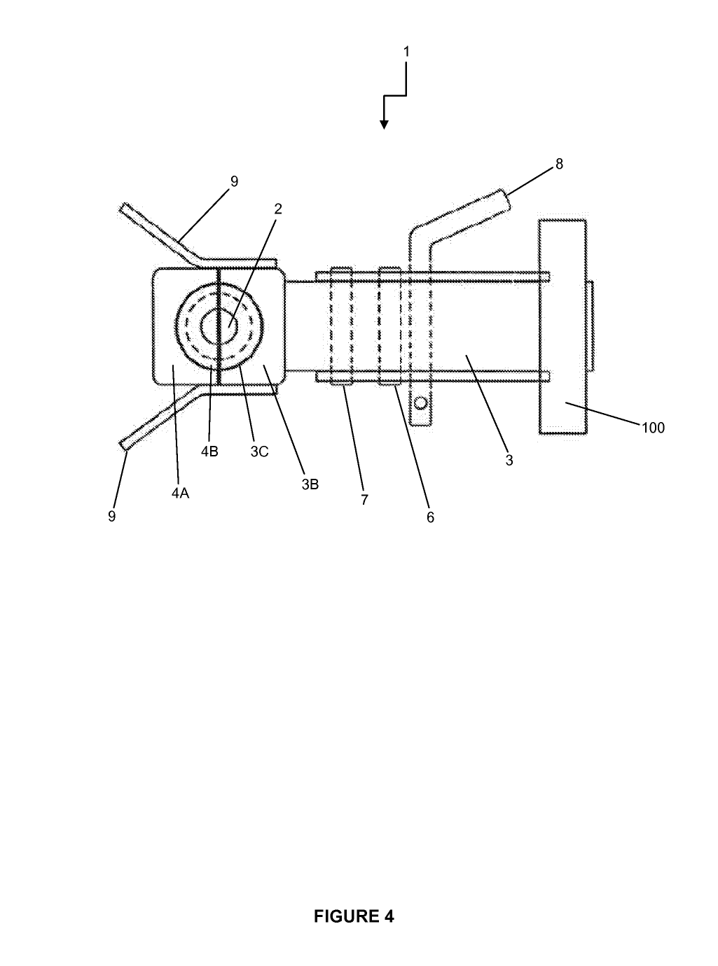

In a preferred form of the invention, a 2000 kg weight capacity apparatus for coupling a trailer to a towing vehicle is generally indicated by arrow 1. A standard 50 mm tow-ball 2 is attached to a towing vehicle (not shown) via a connecting member 2A as is known in the art. The apparatus 1 comprises a support member 3 attached to the body of the trailer 100 (as shown in FIG. 4) at end 3A and further comprising a first abutting portion 3B in the form of a socket with a curved surface 3C configured for abutting a posterior portion 2B of the tow-ball 2.

The apparatus 1 also comprises an pivot arm 4 attached to a pivot plate 5 at a first pivot 6. The pivot arm 4 comprises a second abutting portion 4A in the form of a socket with curved surface 4B configured for abutting an anterior portion 2C of the tow-ball 2.

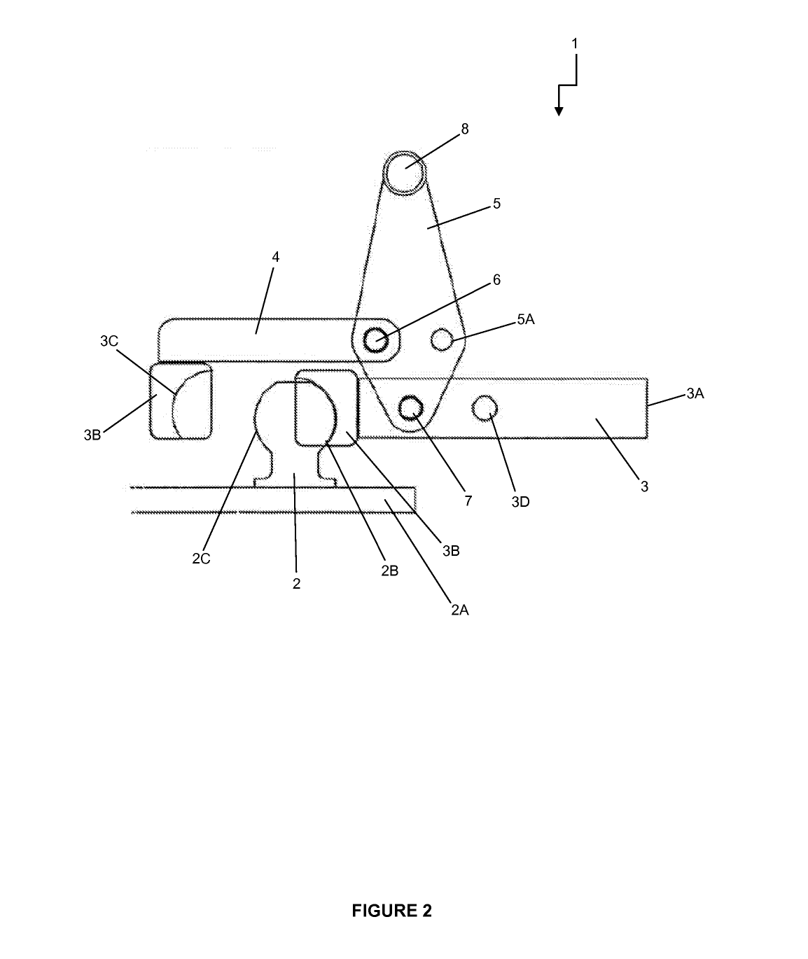

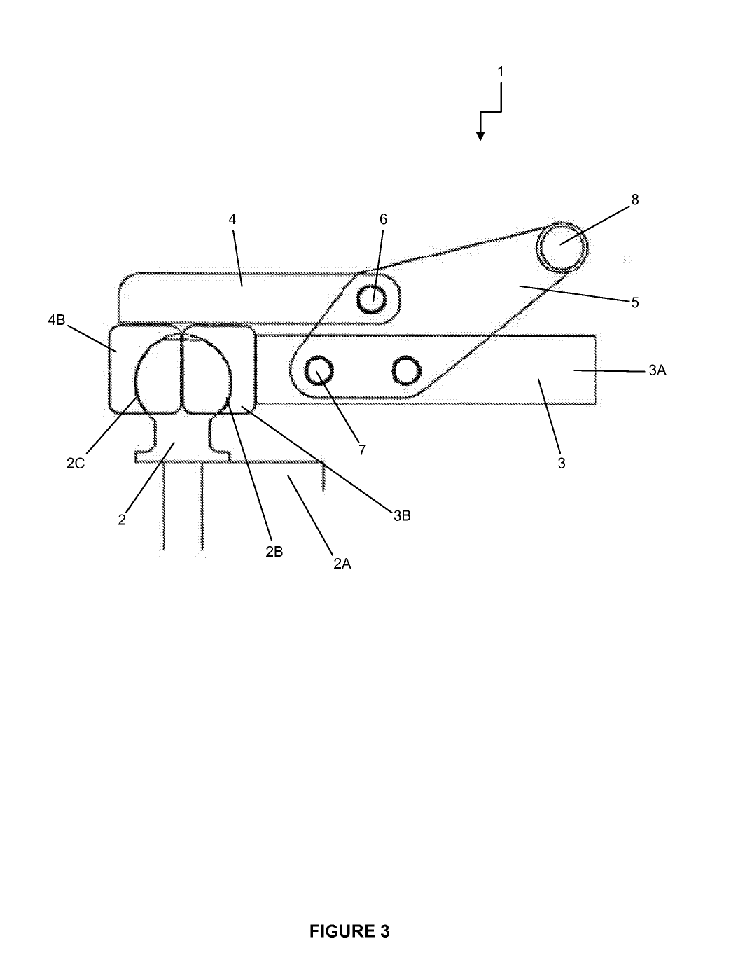

The pivot plate 5 is attached to the support member 3 at a second pivot 7. The position of the pivot plate 5 and connected pivot arm 4 can be adjusted along a length of the support member 3 at apertures 3D (as shown in FIG. 2). Aperture 3D can receive a locking pin (not shown) to secure the pivot plate 5 to the support member 3 when towing a trailer or when the apparatus 1 is not in use. A handle 8 enables movement of the pivot plate 5 between an angled position with respect to the support member 3 (as shown in FIGS. 1 and 3) and an upright position (where the longitudinal axis of the pivot plate 5 is substantially perpendicular with the longitudinal axis of the support member 3; as shown in FIG. 2).

Referring to FIG. 4, a pair of guiding plates 9 are attached to the first abutting portion 3B and are angled to deflect the first abutting portion 3B when in proximity with the posterior portion 2B of the tow-ball 2 to a position where the first abutting portion 3B abuts the tow-ball 2 as the towing vehicle (not shown) is maneuvered into position with respect to the trailer 100. In this way, the first abutting portion 3B can be guided into the abutting position with respect to the tow-ball 2 when the angle of approach of the tow-ball 2 via the towing vehicle is not in exact alignment with the first abutting portion 3B of the trailer 100.

In use, the support member 3 is brought into an abutting position with respect to the posterior portion 2 of the tow-ball 2 via reversing a towing vehicle towards the trailer 100 (as shown in FIG. 1). The guiding plates 9 help in achieving this position as mentioned above.

The pivot plate 5 is then moved manually by the user about pivot 7 via a lever in the form of a handle 8 to the upright position shown in FIG. 2 where the longitudinal axis of the pivot plate 5 is substantially perpendicular with the longitudinal axis of the support member 3. In this position the pivot arm moves about pivot 6 over the tow-ball 2 to a position where a second abutting portion 4B is positioned adjacent the anterior portion 2B of the tow-ball 2.

The pivot plate 5 is then moved manually by the user down toward the support member 3 to an angled position with respect to the support member 3 (as shown in FIG. 3) to bias the first abutting portion 3B and the second abutting portion 4B towards one another to secure the posterior portion 2B and anterior portion 2A of the tow-ball 2 respectively. In this way the trailer is securely coupled to the tow-ball 2 for towing of the trailer 100 by the towing vehicle (not shown). The apparatus 1 is now in a position to receive a locking pin through aperture 5A in the pivot plate 5 when aligned with aperture 3D in the support member 3 (as shown in FIG. 3) to secure the pivot plate 3 in relation to the support member 3 to provide extra security while towing the trailer 100 by the towing vehicle (not shown).

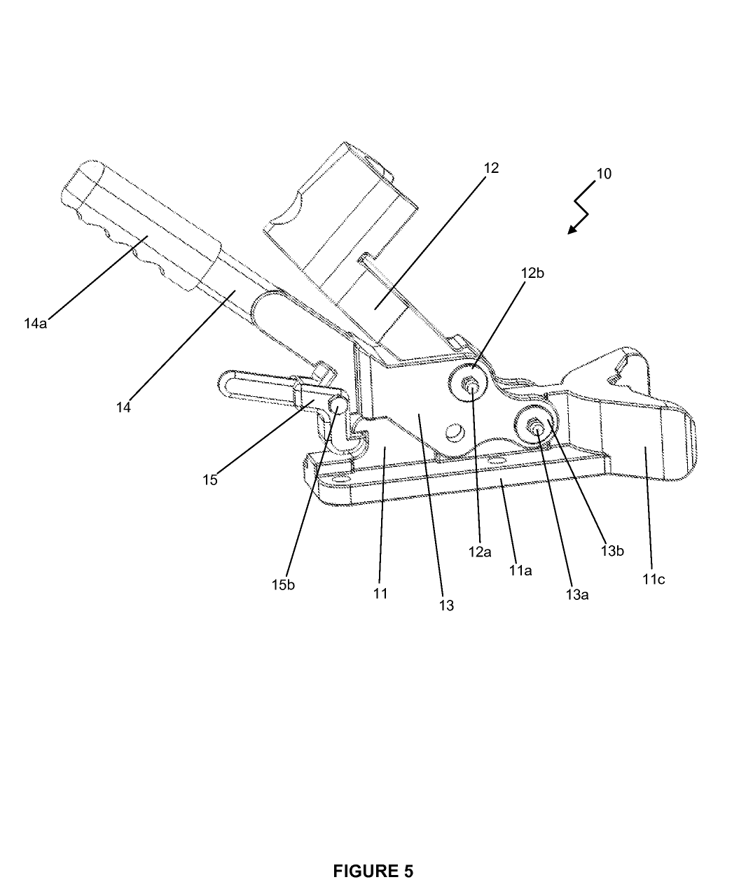

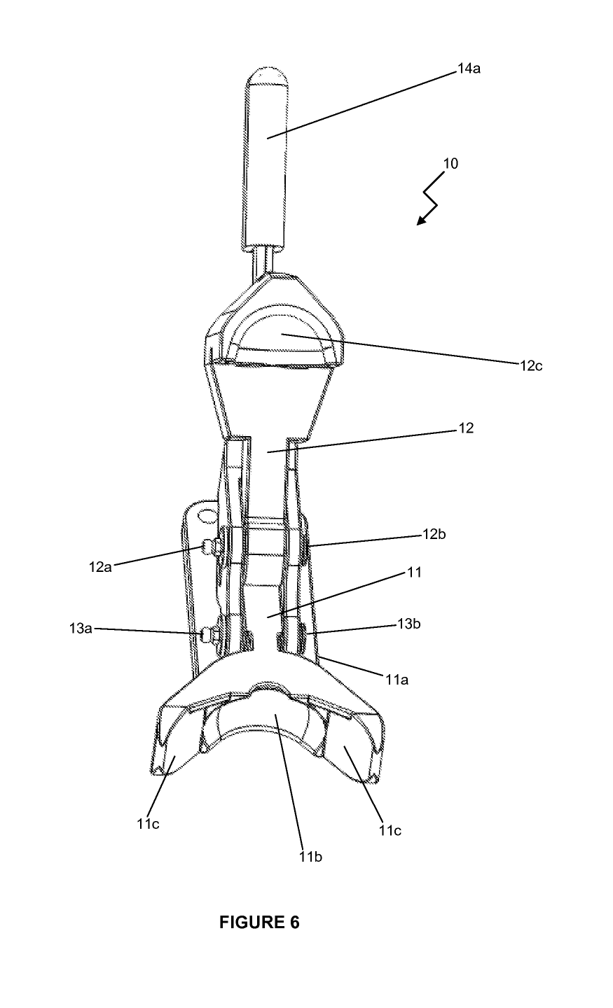

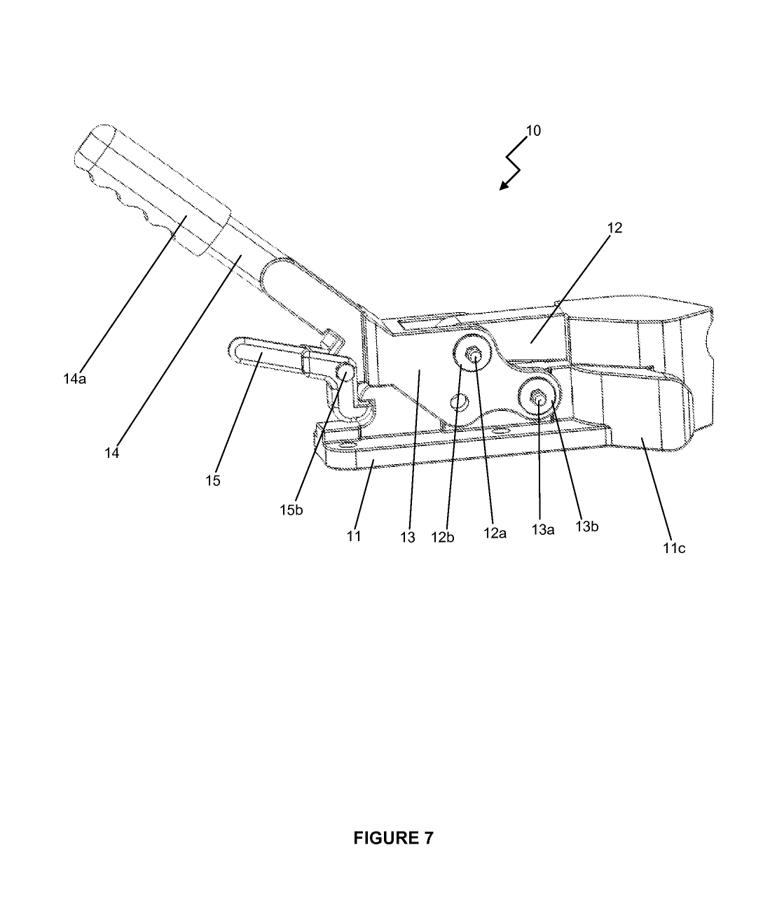

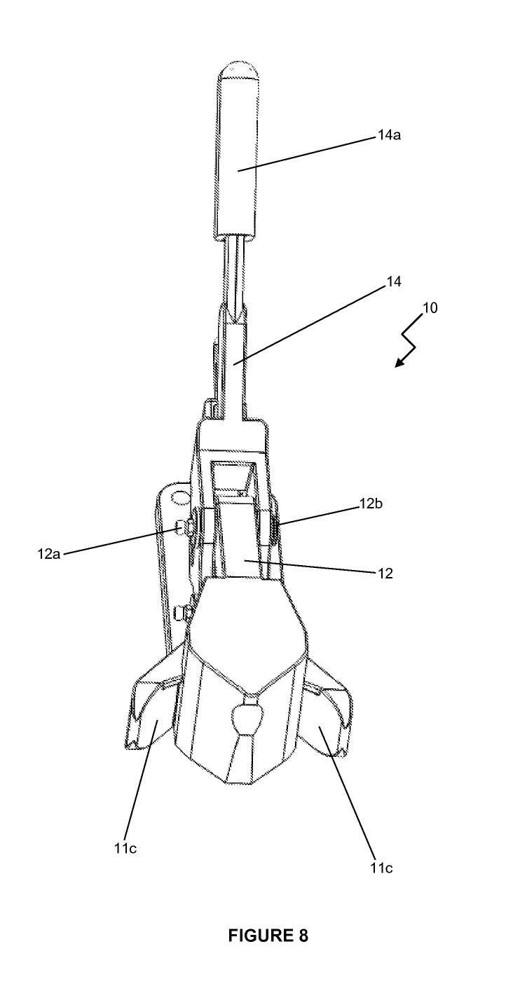

FIGS. 5 to 10 show a second preferred embodiment of the present invention in the form of an apparatus for coupling a trailer to a towing vehicle is generally indicated by arrow 10. Apparatus 10 has a similar arrangement of a support member 11 for attachment to a trailer (not shown) at a base 11a. A first abutting portion 11b incorporates a wide capture mouth in the form of guiding plates 11c.

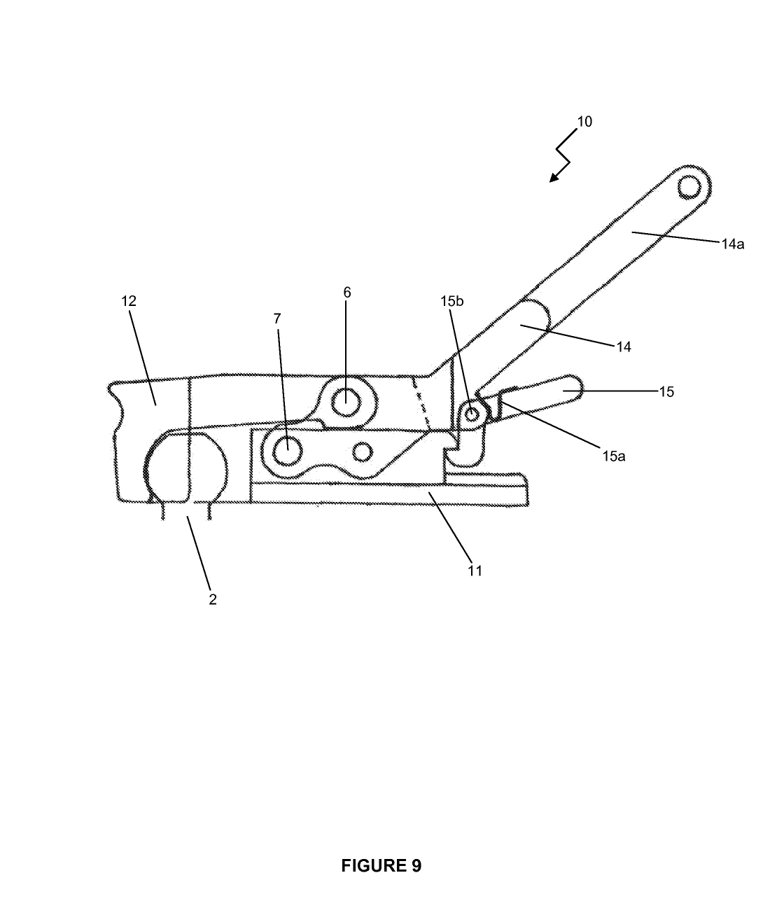

An arm 12 is pivotable on a pivot plate 13 via an M16 pin 12a and locknut 12b. The arm 12 comprises a second abutting portion 12c as described previously. The pivot plate 13 is pivotable on the support member 11 at an M16 pin 13a and locknut 13b. The pivot plate 13 includes a handle 14 including rubber grip 14a to provide leverage for a user to move the pivot plate 13 relative to the support member 11 more easily. Overall operation of the apparatus 10 is as described previously for apparatus 1. The apparatus 10 however also comprises a catch 15 pivotally attached to the pivot plate 13 and configured to attach to the support member 11 to prevent movement of the pivot plate 13 with respect to the support member 11. The catch 15 comprises a tension spring 15a (as seen in FIG. 9) configured to bias the catch to release when the handle 14 is moved relative to the support member 11. The catch 15 pivots via an M6 pin 15b and locknut 15c.

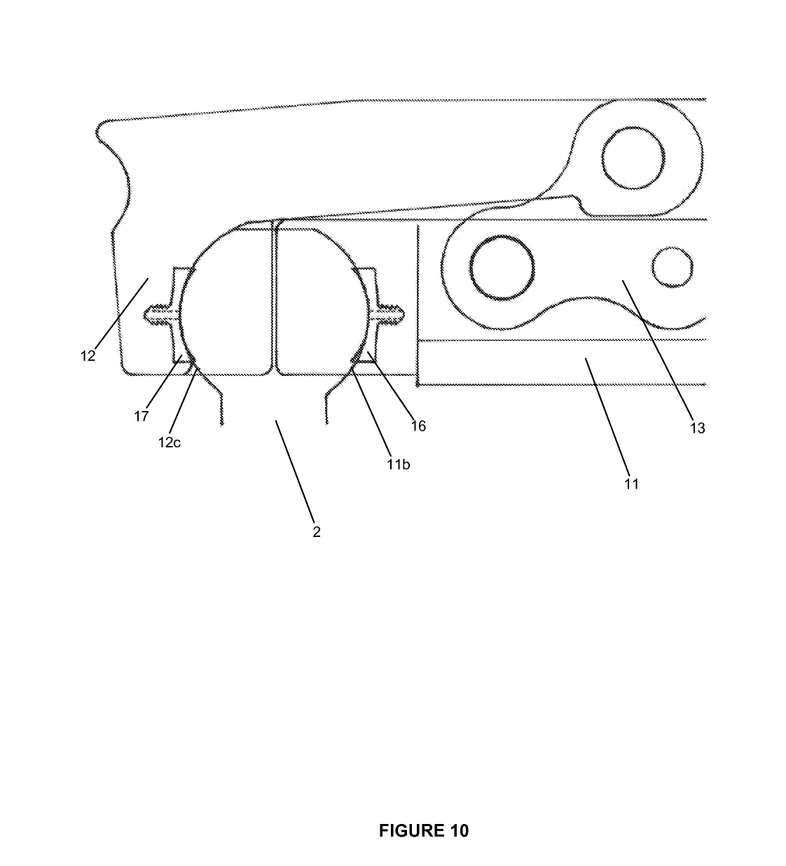

Referring to FIG. 10 the first abutting portion 11b of the support member 11 and the second abutting portion 12c of the pivot arm 12 comprises a friction pad 16 and 17 respectively made of a friction material such as rubber and attached to the curved inner surfaces of the first abutting portion 11b and the second abutting portion 12c to prevent damage to the tow-ball 2 during use.

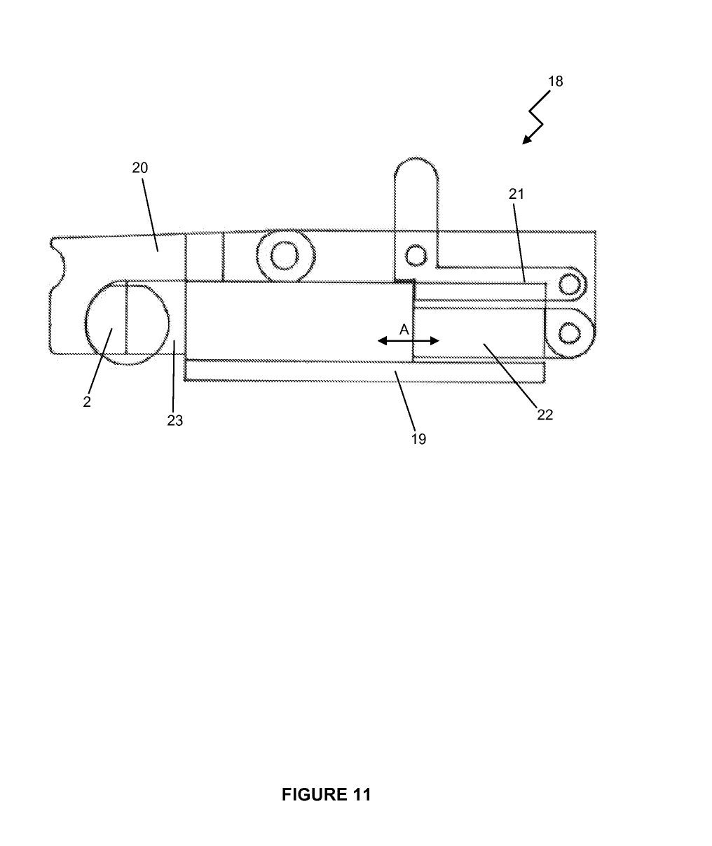

Referring to FIG. 11, a third embodiment of the present invention in the form of an apparatus for coupling a trailer to a towing vehicle is generally indicated by arrow 18. A similar arrangement of support member 19, pivot arm 20 and pivot plate 21 is shown to that of apparatus 1 and 10, except that the position of the support member 19 relative to a trailer (not shown) to which apparatus 18 is attached can be varied in the direction of arrow A via a linear actuator in the form of a 12 v electrically motor driven actuator 22. In this way, ease of use in positioning the first abutting portion 23 of the support member 19 is improved over manual maneuvering of the trailer to make contact between the first abutting portion 23 and the tow-ball 2.

### Example 1

### Load Testing

An Avery Universal test machine IMT 233 was used to load test the preferred embodiment of the present invention shown in FIGS. 1 to 4 coupled to a tow ball to test for failure with the loads shown in Table 1 below:

| | Tests and test loading in KiloNewtons | | |
|---|---|---|---|
| | Longitudinal tension | Vertical | |
| | and compression | tension and | Transverse |
| Item | tests | compression tests | thrust test |
| Light duty ball and | 60 | 25 | 18 |
| coupling (2000 kg) | | | |

The load testing results are shown in Table 2 below:

| | Test Load | | |
|---|---|---|---|
| Configuration | (kN) | Duration | Result |
| Vertical Tension | 25 | 1 minute | No separation of ball |
| | | | from the socket |
| Vertical Compression | 25 | 1 minute | No separation of ball |
| | | | from the socket |
| Longitudinal Tension | 60 | 1 minute | No separation of ball |
| | | | from the socket |
| Longitudinal | 60 | 1 minute | No separation of ball |
| Compression | | | from the socket |
| Transverse Thrust | 18 | 1 minute | No separation of ball |
| | | | from the socket |

The apparatus of the present invention was therefore shown to be safe for use with the specified loads.

It will be appreciated by those skilled in the art that the apparatus 1 may take different forms without departing from the scope of the present invention. For example, the shape and configuration of the first and second abutting portions may be varied to accommodate engaging with tow-ball of different dimensions or different configurations (such as a ring configuration).

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Aspects of the present invention have been described by way of example only and it should be appreciated that modifications and additions may be made thereto without departing from the scope thereof as defined in the appended claims.

What we claim is:

1. An apparatus for coupling a trailer to a towing vehicle, the apparatus comprising:
a support member configured to abut a posterior portion of a tow-ball of the towing vehicle at a first abutting portion positioned at an end of the support member;
a pivot arm configured to pivot over the tow-ball to a position where a second abutting portion positioned on an end of the pivot arm is adjacent an anterior portion of the tow-ball;
a pivot plate connected to the support member at a first pivot and to the pivot arm at a second pivot
wherein
the pivot plate is configured to bias the first abutting portion towards the second abutting portion to securely contact the posterior portion and the anterior portion of the tow-ball respectively.

2. An apparatus for coupling a trailer to a towing vehicle as claimed in claim 1 wherein the first abutting portion and the second abutting portion have a curved inner surface configured to provide maximum contact with an outer surface of the tow-ball.

3. An apparatus for coupling a trailer to a towing vehicle as claimed in claim 1 wherein the first abutting portion and/or the second abutting portion comprise at least one friction pad positioned on the curved inner surface of the first abutting portion and/or the second abutting portion to prevent damage to the tow-ball during use.

4. An apparatus for coupling a trailer to a towing vehicle as claimed in claim 1 wherein the pivot plate comprises a lever configured to move the pivot plate towards the support member to bias the first abutting portion and the second abutting portion towards one another after the second abutting portion of the pivot arm is adjacent the anterior portion of the tow-ball.

5. An apparatus for coupling a trailer to a towing vehicle as claimed in claim 4 wherein the lever comprises a handle to aid the user moving the lever.

6. An apparatus for coupling a trailer to a towing vehicle as claimed in claim 1 wherein the support member also comprises a pair of guiding plates, each guiding plate attached proximal to the first abutting portion of the support member and configured to deflect the support member when in proximity with the tow-ball to a position where the first abutting portion abuts the tow-ball.

7. An apparatus for coupling a trailer to a towing vehicle as claimed in claim 1 wherein the position of the first pivot may be moved by attaching the pivot arm to the support member at one of a series of apertures along a length of the support member via a fixing means.

8. An apparatus for coupling a trailer to a towing vehicle as claimed in claim 1 wherein the apparatus for coupling a trailer to a towing vehicle also comprises a catch pivotally attached to the pivot plate and configured to attach to the support member to prevent movement of the pivot plate with respect to the support member.

9. An apparatus for coupling a trailer to a towing vehicle as claimed in claim 8 wherein the catch comprises a tension spring configured to bias the catch to release from the support member.

10. An apparatus for coupling a trailer to a towing vehicle as claimed in claim 1 wherein, the apparatus for coupling a trailer to a towing vehicle also comprises a locking pin to secure the pivot plate to the support arm.

11. An apparatus for coupling a trailer to a towing vehicle as claimed in claim 1 wherein the apparatus for coupling a trailer to a towing vehicle also comprises a linear actuator configured to move the apparatus to or from a position where the first abutting portion abuts the posterior portion of the tow-ball.

12. An apparatus for coupling a trailer to a towing vehicle as claimed in claim 11 wherein the linear actuator is driven by an electric motor.

13. A method of coupling a trailer to a trailer hitch, the method comprising the steps of:
a. positioning a support member to abut a posterior portion of the tow-ball of a towing vehicle at a first abutting portion positioned at an end of the support member;
b. moving a pivot arm to pivot over the tow-ball to a position where a second abutting portion positioned on an end of the pivot arm is adjacent an anterior portion of the tow-ball; and
c. moving a pivot plate connected to the support member at a first pivot and to the pivot arm at a second pivot to bias the first abutting portion and the second abutting portion towards one another to securely contact the posterior portion and anterior portion of the tow-ball respectively.
